(19) United States
(12) Patent Application Publication
(10) Pub. No.: US 2006/0090525 A1
(43) Pub. Date: May 4, 2006

(54) Tamper resistant lock

(76) Inventor: David Owen Mattson, Chassell, MI (US)

Correspondence Address: MICHAEL BEST & FRIEDRICH, LLP, 100 E WISCONSIN AVENUE, MILWAUKEE, WI, 53202, US

(21) Appl. No.: 11/265,916

(22) Filed: Nov. 3, 2005

Related U.S. Application Data
(60) Provisional application No. 60/624,617, filed on Nov. 3, 2004.

(51) Int. Cl. E05B 73/00

(52) U.S. Cl. 70/18; 70/58

(57) ABSTRACT

A single use, tamper resistant lock that can be applied without tools. The lock has a lock body and flexible cable having a first end coupled to the lock body. Another portion of the cable is selectively engagable with and secured to the lock body to secure an item to be locked. This portion of the cable is secured to the lock body with a frangible locking member. The frangible locking member has a flared end coupled to a threaded body at a frangible neck. The flared head of the frangible locking member can be sufficiently engaged and manipulated by hand to thread the threaded body into the lock body and secure the cable to the lock body without the need for tools. As the cable is secured, the flared head separates from the threaded body at the frangible neck due to the hand-applied torque.

### RELATED APPLICATIONS

The present application claims the benefit of co-pending provisional patent application Ser. No. 60/624,617, filed Nov. 3, 2004, the subject matter of which is hereby incorporated by reference.

### BACKGROUND

Tamper resistant locks are used in many applications to either prevent tampering or to provide indication of tampering. Generally, tamper resistant locks are intended to be used only a single time. Once the lock is applied, it is generally at least partially destroyed when removed. If an unauthorized person removes the lock, it cannot be reapplied. Thus, it provides an indication that tampering has occurred.

As explained above, some locks are designed to prevent tampering. Some of these types of locks have a metal hoop that is held in place by a locking body. This type of lock generally prevents tampering due to the robust construction of the lock. However, the locking body of this type of lock is generally separated from the hoop prior to use. Accordingly, if one part is lost, the lock is rendered inoperable.

Other locks are not as robust and are generally intended to indicate whether tampering has occurred. Many locks of this type do not have multiple loose parts. Rather, it can have a unitary construction. Accordingly, the lock cannot be rendered inoperable due to lost parts. This type of lock is generally characterized as being weak and fragile, and can be made from thin metal or plastic. For example, these types of locks can include zip-ties and other similar structures.

### SUMMARY OF THE INVENTION

The present invention is directed toward a single use, tamper resistant lock that can be applied without tools. In other words, the lock can be applied by hand and yet sufficiently secure a device to prevent tampering. In some embodiments, the lock has a relatively simple, unitary construction that prevents the loss of parts that can render conventional locks inoperable. Furthermore, the lock is flexible and adjustable. Accordingly, it can be used for many different applications.

One embodiment is directed toward a tamper resistant lock having a lock body and flexible cable having a first end coupled to the lock body. Another portion of the cable is selectively engagable with and secured to the lock body to secure an item to be locked. This portion of the cable is secured to the lock body with a frangible locking member. The frangible locking member has a flared end coupled to a threaded body at a frangible neck. The flared head of the frangible locking member can be sufficiently engaged and manipulated by hand to thread the threaded body into the lock body and secure the cable to the lock body without the need for tools. As the cable is secured, the flared head of the frangible locking member separates from the threaded body at the frangible neck due to the hand applied torque.

These and other aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is a plan view of a lock embodying aspects of the present invention.

FIG. 2 is a side view of a frangible locking member of the lock illustrated in FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

### DESCRIPTION OF THE ILLUSTRATED EMBODIMENTS

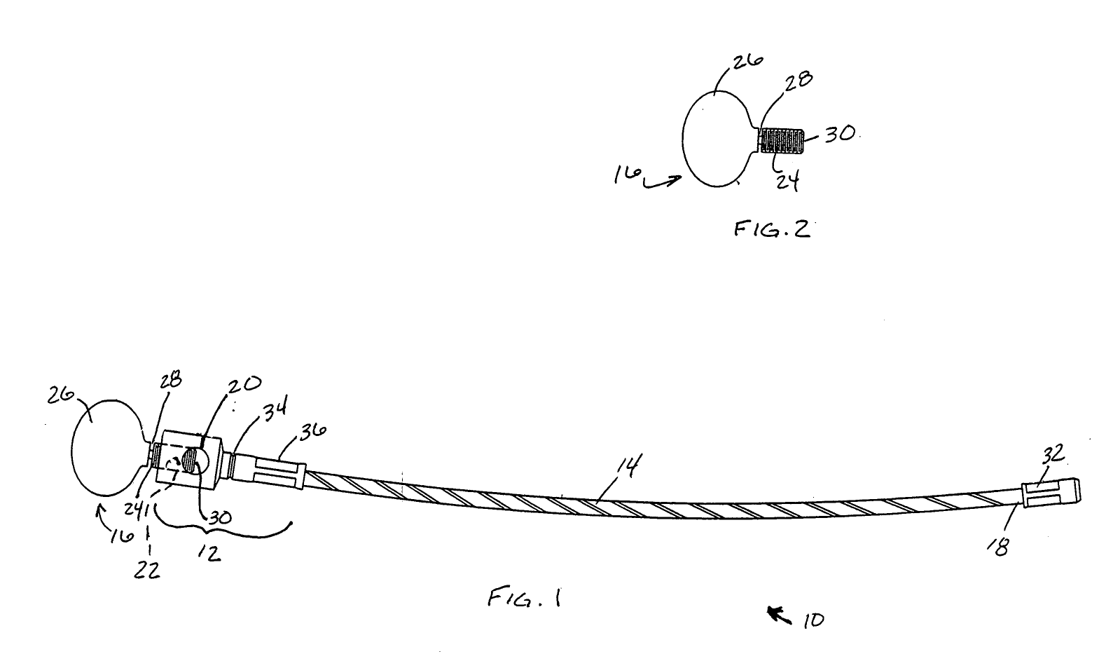

The lock 10 illustrated in FIG. 1 includes a lock body 12, a flexible cable 14 coupled to the lock body 12, and a frangible locking member 16 (also in FIG. 2) coupled to the lock body and movable to engage a portion of the flexible cable 14. As described in greater detail below, a free end 18 of the flexible cable 14 can be inserted into an aperture 20 of the lock body 12 and secured within the aperture 20 by the frangible locking member 16.

The lock body 12 is coupled to the flexible cable 14 at a first end of the lock body 12. Although the flexible cable 14 can be secured to the lock body 12 many different ways, the cable 14 in the illustrated embodiment is coupled to the lock body 12 via a crimped end of the lock body 12.

As indicated above, the lock body 12 includes an aperture or eyelet 20 for receiving the free end 18 of the flexible cable 14. This aperture 20 extends entirely through the lock body 12 to allow the flexible cable 14 to pass through the lock body. Accordingly, when the lock 10 is used, the amount of cable 14 passing through the aperture 20 can be adjusted depending upon the object being locked. As illustrated, the aperture 20 passes through the body in a direction that is generally perpendicular to the direction in which the flexible cable 14 extends from the lock body 12 in an unlocked, at rest condition (i.e., as illustrated in FIG. 1). In other embodiments, however, the aperture 20 can be oriented differently. For example, if the lock body 12 extended sufficiently from the cable 14 in a radial direction relative to the cable, the aperture 20 could be positioned substantially parallel to the cable 14.

The body also includes a second aperture 22. The second aperture 22 is adapted to receive the frangible locking member 16. Specifically, the second aperture 22 is internally threaded to receive the frangible locking member 16. The second aperture 22 is positioned substantially perpendicular to aperture 20. The second aperture 22 also intersects aperture 20. This configuration allows the frangible locking member 16 to be threaded into aperture 22 to selectively engage the flexible cable 14 positioned in aperture 20.

As illustrated in FIGS. 1 and 2, the frangible locking member 16 has a threaded body 24, a flared head 26, and a frangible neck 28 positioned between the threaded body 24 and the flared head 26. The threaded body 24 is dimensioned and configured to be received within aperture 22. The threaded body 24 is rotatable within aperture 22 to move a cable-engaging end 30 to a position in which the cable-engaging end 30 intersects aperture 20 and contacts the flexible cable 14. As described in greater detail below, the cable-engaging end 30 of the threaded body 24 is adapted to engage the flexible cable 14 and secure the flexible cable 14 within aperture 20. The cable-engaging end 30 acts as a set screw to secure the flexible cable 14.

As illustrated, the flared head 26 of the frangible locking member 16 has an enlarged generally flat portion. Although the flared head 26 is described as being generally flat, it should be understood that the surface of the flared head could be concave or convex. The flared head 26 is dimensioned and configured to be rotated by a person's fingers without the need for tools, such as a wrench. Accordingly, this general configuration of the frangible locking member 16 is sometimes referred to as a wing-bolt, thumb-bolt, or thumb-screw.

The frangible locking member 16 has a frangible neck 28 positioned between the flared head and the threaded body 24. The frangible neck 28 has a reduced diameter relative to the threaded body portion 24. For example, in one particular embodiment, the diameter of the threaded body 24 portion is about 6 mm, while the diameter of the neck 28 is about 3 mm. The reduced diameter of the frangible neck 28 allows the neck to break when a predetermined load is applied to the neck 28 as the flared head 26 is rotated to engage the threaded body 24 with the flexible cable 14. The neck 28 breaks to separate the flared head 26 from the threaded body 24 once the threaded body 24 is sufficiently engaged with the flexible cable 14. Without the flared head 26 attached to the threaded body 24, it is unlikely that the threaded body 24 can be rotated to disengage the flexible cable 14.

The predetermined load needed to sufficiently engage the frangible locking member 16 with the cable 14 can be dependent upon the amount of security desired and the type of components used to make the lock 10. For example, the amount of torque needed to sufficiently engage the threaded body 24 with the flexible cable 14 can depend upon the type of cable used. Specifically, some cables can be constructed to allow the cable-engaging end 30 of the frangible locking member 16 to deform, penetrate, or otherwise engage the cable due to relatively little applied torque compared to other constructions of the cable 14. However, the predetermined load should fall within a range that can be applied by hand without the need for tools. Accordingly, in some embodiments, sufficient engagement between the threaded body 24 and the flexible cable 14 can be generated at a break-off torque as low as about 10 inch-pounds of force. Experimentally, it has been determined that a break-off torque of about 30 to about 40 inch-pounds can be generated in the illustrated embodiment without the need for tools and yet cause the threaded body to sufficiently engage the flexible cable 14. However, the amount of torque that can be applied by hand depends upon the construction of the frangible locking member 16. For example, greater break-off torque can be generated without tools by providing a larger head 26 having a longer lever relative to the axis of rotation of the frangible locking member 16. The use of alternative designs of the frangible locking member 16 generally needs to be balanced with the overall size, cost, and weight of the lock 10.

The flexible cable 14 can be made from a variety of materials. In some embodiments, the flexible cable 14 is made from steel cable. More specifically, the flexible cable 14 can be a braided steel cable or aircraft cable. This type of cable is very strong and is highly resistant to being cut. Furthermore, due to the braided design, the cable-engaging end 30 of the threaded body 24 can tightly pinch the cable 14 within aperture 20 with relatively little force. Specifically, as described above, the necessary force can be developed by a person's hand (without the need for tools) rotating the flared head 26 of the frangible locking member 16. Such hand tightening of the threaded body 24 against the cable 14 can prevent relative movement between the cable 14 and the threaded body 24 with tension forces of over 1,000 pounds being applied to the cable 14.

The flexible cable 14 also has a crimped end cap 32 located on the free end 18 of the cable 14. Although the cap 32 can help to prevent the cable 14 from fraying or snagging, it can also help to secure the lock 10. Specifically, the cap 32 is rigid and has a diameter that is greater than the diameter of the cable 14. This cap 32 can engage the threaded body 24 of the frangible locking member 16 to continue to secure the lock 10 when sufficient tensile forces (e.g., greater that 1,000 pounds) are applied to the cable 14 to cause the cable to move relative to the threaded body 24. In other words, if the cable 14 beings to slip due to applied tensile forces, the cap 32 will engage the threaded body 24 and prevent further slipping of the cable 14 relative to the aperture 20. Accordingly, the lock 10 remains secured. This cap 32 can prevent failure of the lock 10 as about an additional 1,000 pounds of tensile force is applied to the cable 14. Thus, due to the cap 32, the lock 10 will not open or break until over 2,000 pounds of tensile force are applied to the cable 14.

The lock 10 also has a cut-off location 34. The cut-off location is predefined on the lock body 12 at a location that is generally easy to cut through relative to the remainder of the lock 10. As illustrated, the cut-off location 34 has a reduced dimension relative to the remainder of the lock body 12. In the illustrated embodiment, the reduced dimension is a smaller diameter portion compared to the remainder of the lock body 12. The cut-off location 34 is positioned adjacent a crimp 36 connecting the flexible cable 14 to the lock body 12. At this location, one does not have to cut through the flexible cable 14, which is quite difficult. Rather, a bolt cutter or grinder can cut through this portion of the lock body 12 relatively easy to allow the lock 10 to be removed.

During assembly of the lock 10, the lock body 12 is crimped to the flexible cable 14 and the free end 18 of the flexible cable 14 is crimped to cap 32. The frangible locking member 16 is also at least partially threaded into aperture 22 of the lock body 12. Accordingly, the lock 10 can be distributed and/transported as a unitary device without the possibility of losing parts and rendering the lock 10 inoperable.

In operation, the free end 18 of the flexible cable 14 is fed through an item to be locked and is then fed through the aperture 20 in the lock body 12. The lock 10 can then be adjusted by pulling a desired amount of cable 14 through the aperture 20. Once the desired amount of cable 14 extends through aperture 20, the frangible locking member 16 can be rotated to secure the cable 14 within the aperture 20 and can be moved from an unlocked position (shown in FIG. 1), in which the frangible locking member 16 is spaced a distance from the cable 14, toward a locking position, in which the frangible locking member 16 lockingly engages the flexible cable 14. As discussed above, the frangible locking member 16 can be rotated by hand without the need for a tool by grasping the flared head 26 and applying a torque. As the frangible locking member 16 is rotated, the cable-engaging end 30 of the threaded body 24 engages and pinches the cable 14 against a portion of the aperture 20 to secure the lock 10. Once a sufficient torque is applied to the frangible locking member 16, the lock 10 will be secured and the flared head 26 will break off of the threaded body at the frangible neck 28 to lockingly secure the frangible locking member 16 in the lock body 12.

While the lock 10 is secured, tensile forces can be applied to the lock 10 to attempt to open the lock 10. Generally, the cable 14 will not move relative to threaded body 24 until tensile forces greater than about 1,000 pounds are applied to the cable 14. However, even after the cable 14 beings to slip relative to the threaded body 24, the lock 10 will remain secured until the tensile forces are more than doubled. Specifically, after a certain amount of slippage, the crimped cap 32 will abut the threaded body 24. This abutment will prevent the crimped cap 32 from passing through the aperture 20 in the lock body 12. Generally, the cap 32 will resist tensile forces of about 2,000 pounds.

To remove the lock 10 from the item being secured, a bolt cutter or grinder can be applied to the cut-off location 34 of the lock body 12. This will cause the lock body 12 to separate into two different parts, which will allow the lock 10 to be removed.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments. All of these different combinations constitute various alternative aspects of the present invention.

Various features of the invention are set forth in the following claims.

What is claimed is:

1. A tamper-resistant lock comprising:
a lock body defining a first aperture and a second aperture communicating with the first aperture;
an elongated flexible member being selectively insertable into the first aperture; and
a locking member including a frangible neck and being insertable into the second aperture to selectively lockingly engage the elongated flexible member in the lock body.

2. The lock according to claim 1, wherein the elongated flexible member includes a first end and a second end, the first end being connected to the lock body and the second being selectively lockingly engagable with the locking member in the lock body.

3. The lock according to claim 2, wherein the elongated flexible member is a braided cable, and wherein the second end includes a cap for preventing the cable from unwinding.

4. The lock according to claim 1, wherein the locking member threadably engages the lock body in the second aperture.

5. The lock according to claim 1, wherein the elongated flexible member is a steel cable.

6. The lock according to claim 1, wherein the lock is a tool-less lock.

7. The lock according to claim 1, wherein the frangible neck includes a tapered section to facilitate shearing.

8. The lock according to claim 7, wherein, when a predetermined load is applied to the locking member, the frangible neck is sheared at the tapered section.

9. The lock according to claim 7, wherein, when the tapered section is sheared, the locking member lockingly engages the locking body.

10. The lock according to claim 1, wherein the locking member includes a thumb screw.

11. The lock of claim 1, wherein the first aperture defines an axis, and wherein the second aperture extends through the lock body in a direction substantially normal to the axis.

12. The lock of claim 1, wherein the lock body includes a tapered section at least partially defining a cut-off location.

13. A tamper-resistant lock comprising:
a lock body defining a first aperture and a second aperture communicating with the first aperture;
an elongated member including a first end connected to the lock body and having a second end selectively insertable into the first aperture; and
a locking member including a flared head for operation by an operator's fingers, the locking member being insertable into the second aperture to selectively lockingly engage the elongated member in the lock body and being frangible to lockingly engage the lock body.

14. The lock according to claim 13, wherein the elongated member is flexible.

15. The lock according to claim 14, wherein the elongated member is a braided cable, and wherein the second end includes a cap for preventing the cable from unwinding.

16. The lock according to claim 14, wherein the flexible member is a steel cable.

17. The lock according to claim 13, wherein the locking member threadably engages the lock body in the second aperture.

18. The lock according to claim 13, wherein the lock is a tool-less lock.

19. The lock according to claim 13, wherein the locking member includes a frangible neck having a tapered section to facilitate shearing.

20. The lock according to claim 19, wherein, when a predetermined load is applied to the locking member, the frangible neck is sheared at the tapered section.

21. The lock according to claim 20, wherein, when the tapered section is sheared, the locking member lockingly engages the locking body.

22. The lock of claim 13, wherein the lock body includes a cut-off location.

23. A method of operating a tamper-resistant lock, the method comprising the acts of:
providing a lock body defining a first aperture and a second aperture communicating with the first aperture;
inserting an elongated flexible member into the first aperture;
inserting a locking member into the second aperture and moving the locking member relative to the lock body toward an unlocked position, in which the locking member is spaced a distance from the elongated flexible member;
moving the locking member relative to the lock body toward a locking position, in which the locking member secures the elongated flexible member between the locking member and the lock body, the locking member having a neck and a head; and
separating the head from the neck of the locking member to secure the locking member in the lock body in the locking position.

24. The method of claim 23, wherein the lock body includes a tapered section, and further comprising the act of cutting the tapered section of the lock body to at least partially separate the elongated flexible member and the lock body.
